(19) United States
(12) Patent Application Publication
(10) Pub. No.: US 2025/0274556 A1
(43) Pub. Date: Aug. 28, 2025

(54) IMAGE FORMING APPARATUS AND IMAGE FORMING METHOD

(71) Applicant: KYOCERA Document Solutions Inc., Osaka (JP)

(72) Inventors: Yasuaki Sakamoto, Osaka (JP); Makoto Matsumoto, Osaka (JP); Masaru Watanabe, Osaka (JP); Ayato Morikami, Osaka (JP); Yukiko Kotani, Osaka (JP); Atsuki Ito, Osaka (JP)

(21) Appl. No.: 19/065,069

(22) Filed: Feb. 27, 2025

(30) Foreign Application Priority Data
Feb. 28, 2024 (JP) 2024-028668

(51) Int. Cl. H04N 1/60; G03G 15/01

(52) U.S. Cl. CPC H04N 1/6027; G03G 15/0121; G03G 15/0194

(57) ABSTRACT

An image forming apparatus includes an image forming portion, a first image processing portion, and a second image processing portion. The first image processing portion executes a plurality of types of image formation condition adjustment processes of the image forming portions on the image forming units used for monochrome printing in units of a specific number of condition adjustment processes in order whenever an execution history of the monochrome printing satisfies a monochrome adjustment condition set in advance. The plurality of types of condition adjustment processes is set in advance. The second image processing portion executes the plurality of types of condition adjustment processes on the image forming unit of the plurality of image forming units used for color printing in units of a specific number of condition adjustment processes in order whenever an execution history of the color printing satisfies a color adjustment condition set in advance.

### INCORPORATION BY REFERENCE

This application is based upon and claims the benefit of priority from the corresponding Japanese Patent Application No. 2024-028668 filed on Feb. 28, 2024, the entire contents of which are incorporated herein by reference.

This disclosure relates to an image forming apparatus and an image forming method.

### BACKGROUND

An electrophotographic image forming apparatus includes an image forming portion that forms an image based on input image data on a transfer destination object. In the image forming apparatus, condition adjustment processes of adjusting various image formation conditions such as the amount of laser light and a developing bias voltage are sometimes executed. In addition, technology of controlling the execution frequency of each of the condition adjustment processes by taking into consideration the frequency of color printing has been known.

In each of the condition adjustment processes, a sensing toner image used for the condition adjustment process is formed on a transfer destination object such as an intermediate transfer belt and an image formation condition is adjusted on the basis of a result of sensing the density, the position, or the like of the sensing toner image.

### SUMMARY

An image forming apparatus according to an aspect of this disclosure includes an image forming portion, a first image processing portion, and a second image processing portion. The image forming portion includes a plurality of image forming units corresponding to a plurality of colors. The image forming portion executes monochrome printing of printing a monochrome image or color printing of printing a color image on the basis of input image data. The first image processing portion executes a plurality of types of condition adjustment processes of adjusting an image formation condition of the image forming portion on the image forming unit of the plurality of image forming units used for the monochrome printing in units of a specific number of condition adjustment processes in order whenever an execution history of the monochrome printing satisfies a monochrome adjustment condition set in advance. The plurality of types of condition adjustment processes is set in advance. The second image processing portion executes the plurality of types of condition adjustment processes on the image forming unit of the plurality of image forming units used for the color printing in units of a specific number of condition adjustment processes in order whenever an execution history of the color printing satisfies a color adjustment condition set in advance.

An image forming method according to another aspect of this disclosure is executed by a processor of an image forming apparatus including an image forming portion including a plurality of image forming units corresponding to a plurality of colors. The image forming portion executes monochrome printing of printing a monochrome image or color printing of printing a color image on the basis of input image data. In the image forming method, a step of executing a plurality of types of condition adjustment processes of adjusting an image formation condition of the image forming portion on the image forming unit of the plurality of image forming units used for the monochrome printing in units of a specific number of condition adjustment processes in order whenever an execution history of the monochrome printing satisfies a monochrome adjustment condition set in advance is executed. The plurality of types of condition adjustment processes is set in advance. In addition, in the image forming method, a step of executing the plurality of types of condition adjustment processes on the image forming unit of the plurality of image forming units used for the color printing in units of a specific number of condition adjustment processes in order whenever an execution history of the color printing satisfies a color adjustment condition set in advance is executed.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a cross-sectional view of a configuration of an image forming apparatus according to an embodiment of this disclosure.

FIG. 2 is a block diagram showing a system configuration of the image forming apparatus according to the embodiment of this disclosure.

FIG. 3 is a schematic diagram showing a configuration of an image forming portion of the image forming apparatus according to the embodiment of this disclosure.

FIG. 4 is a bottom view of a configuration of an intermediate transfer belt of the image forming apparatus according to the embodiment of this disclosure.

FIG. 5 is a flowchart showing an example of an adjustment control process that is executed by the image forming apparatus according to the embodiment of this disclosure.

FIG. 6 is a diagram showing an example of a result of execution of the adjustment control process that is executed by the image forming apparatus according to the embodiment of this disclosure.

### DETAILED DESCRIPTION

Hereinafter, an embodiment of this disclosure will be described with reference to the accompanying drawings. It is to be noted that the following embodiments are specific examples of this disclosure and do not limit the technical scope of this disclosure.

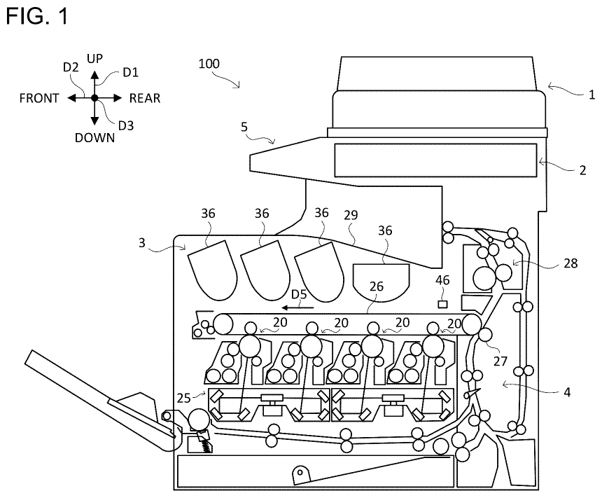

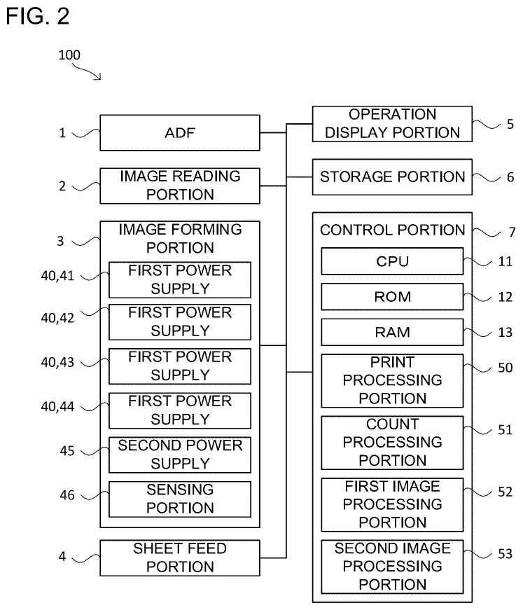

First, the configuration of an image forming apparatus 100 according to an embodiment of this disclosure will be described with reference to FIGS. 1 and 2.

It is to be noted that the perpendicular direction with the image forming apparatus 100 placed in an installation state (state shown in FIG. 1) that allows for use is defined as an up-down direction D1 for convenience of description. In addition, a front-back direction D2 is defined by using the surface of the image forming apparatus 100 shown in FIG. 1 corresponding to the left of FIG. 1 as a front (front surface). Furthermore, a left-right direction D3 is defined on the basis of the front of the image forming apparatus 100 in the installation state.

The image forming apparatus 100 is a multifunction peripheral having a plurality of functions such as a facsimile function and a copy function along with a scan function of reading an image on a document sheet and a print function of forming an image on the basis of image data. It is to be noted that this disclosure may be applied to an image forming apparatus such as a printer, a facsimile apparatus, and a copier each capable of forming an image by electrophotography.

As shown in FIGS. 1 and 2, the image forming apparatus 100 includes an auto document feeder (ADF) 1, an image reading portion 2, an image forming portion 3, a sheet feed portion 4, an operation display portion 5, a storage portion 6, and a control portion 7.

The ADF 1 conveys a document sheet to be read by the scan function. The ADF 1 includes a document sheet set portion, a plurality of conveying rollers, a document sheet holder, and a sheet discharge portion.

The image reading portion 2 achieves the scan function. The image reading portion 2 includes a document sheet table, a light source, a plurality of mirrors, an optical lens, and a charge coupled device (CCD).

The image forming portion 3 achieves the print function. Specifically, the image forming portion 3 forms a color or monochrome image on a sheet supplied from the sheet feed portion 4 in accordance with electrophotography.

The sheet feed portion 4 supplies a sheet to the image forming portion 3. The sheet feed portion 4 includes a sheet feed cassette, a manual feed tray, and a plurality of conveying rollers. It is to be noted that the control portion 7 allows the sheet type of print target sheets stored in the sheet feed cassette to be set in advance in response to a user operation. In particular, in a case where the sheet feed portion 4 is provided with a plurality of the sheet feed cassettes, it is possible to set the sheet type for each of the sheet feed cassettes.

The operation display portion 5 is a user interface of the image forming apparatus 100. The operation display portion 5 includes a display portion such as a liquid-crystal display that displays various kinds of information in response to a control instruction from the control portion 7 and an operation portion such as an operation key or a touch panel that inputs various kinds of information to the control portion 7 in response to an operation of a user.

The storage portion 6 is a non-volatile storage device. For example, the storage portion 6 is a non-volatile memory such as a flash memory. It is to be noted that the storage portion 6 may be a solid state drive (SSD) or a hard disk drive (HDD).

The control portion 7 integrally controls the image forming apparatus 100. As shown in FIG. 2, the control portion 7 includes a CPU 11, a ROM 12, and a RAM 13. The CPU 11 includes one or more processors that execute various calculation processes. The ROM 12 is a non-volatile storage device in which information about a control program or the like for causing the CPU 11 to execute various processes is stored in advance. The RAM 13 is a volatile or non-volatile storage device that is used as a temporary storage memory (work area) for various processes which are executed by the CPU 11. The CPU 11 integrally controls the image forming apparatus 100 by executing various control programs stored in the ROM 12 in advance.

It is to be noted that the control portion 7 may be a control portion provided separately from a main control portion which integrally controls the image forming apparatus 100. In addition, the control portion 7 may include an electronic circuit such as an integrated circuit (ASIC).

### [Configuration of Image Forming Portion 3]

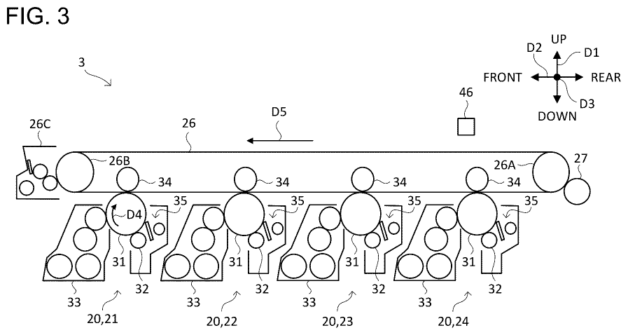

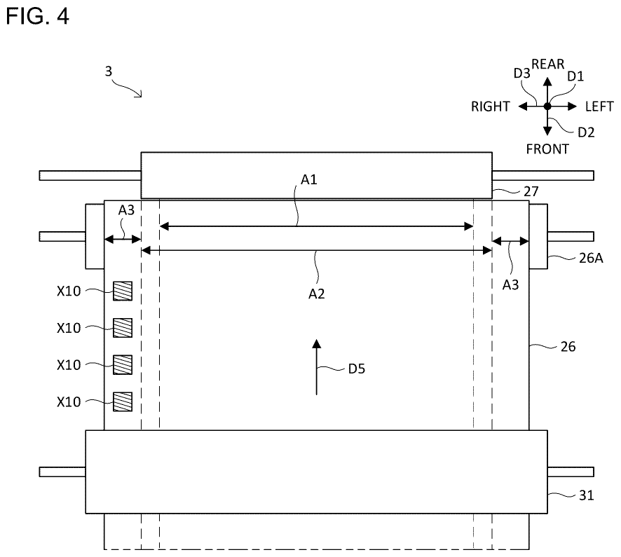

Next, the configuration of the image forming portion 3 will be described with reference to FIGS. 1 to 4. Here, FIG. 3 is a schematic diagram showing the configurations of an image forming unit 20, an intermediate transfer belt 26, and a secondary transfer roller 27. In addition, FIG. 4 is a bottom view of the configurations of a photoconductor drum 31, the intermediate transfer belt 26, a drive roller 26A, and the secondary transfer roller 27 of an image forming unit 24.

As shown in FIG. 1, the image forming portion 3 includes the four image forming units 20, a laser scanning unit 25, the intermediate transfer belt 26, the secondary transfer roller 27, a fixing device 28, and a sheet discharge tray 29. In addition, as shown in FIGS. 2 and 3, the image forming portion 3 includes four first power supplies 40, a second power supply 45, and a sensing portion 46. The image forming portion 3 then executes monochrome printing of printing a monochrome image or color printing of printing a color image on the basis of input image data.

The four image forming units 20 include image forming units 21 to 24 corresponding to a plurality of colors. The image forming unit 21 (see FIG. 3) forms a toner image of Y (yellow). The image forming unit 22 (see FIG. 3) forms a toner image of C (cyan). The image forming unit 23 (see FIG. 3) forms a toner image of M (magenta). The image forming unit 24 (see FIG. 3) forms a toner image of K (black). As shown in FIGS. 1 and 3, the four image forming units 20 are provided side by side along the front-back direction D2 in the order of yellow, cyan, magenta, and black from the front side of the image forming apparatus 100.

As shown in FIG. 3, each of the image forming units 20 includes the photoconductor drum 31, a charging roller 32, a developing device 33, a primary transfer roller 34, and a drum cleaning member 35. In addition, each of the image forming units 20 includes a toner container 36 shown in FIG. 1.

An electrostatic latent image is formed on a surface of the photoconductor drum 31. For example, the photoconductor drum 31 includes a photosensitive layer formed by using amorphous silicon. The photoconductor drum 31 receives rotational driving force supplied from an unillustrated motor and rotates in a drum rotation direction D4 shown in FIG. 3. This causes the photoconductor drum 31 to convey the electrostatic latent image formed on the surface.

The charging roller 32 receives the application of a charged voltage set in advance and charges the surface of the photoconductor drum 31. For example, the charging roller 32 charges the surface of the photoconductor drum 31 with positive polarity. The surface of the photoconductor drum 31 charged by the charging roller 32 is irradiated with light emitted from the laser scanning unit 25 and based on image data. This forms the electrostatic latent image on the surface of the photoconductor drum 31.

The developing device 33 develops the electrostatic latent image formed on the surface of the photoconductor drum 31. The developing device 33 includes a pair of stirring members, a magnet roller, and a developing roller. The pair of stirring members stirs a developer including a toner and a carrier and stored inside the developing device 33. For example, the toner included in the developer is charged with positive polarity by the friction with the carrier included in the developer. The magnet roller draws up the developer stirred by the pair of stirring members and supplies the toner included in the developer to the developing roller. The developing roller conveys the toner supplied from the magnet roller to the opposed position to the photoconductor drum 31. In addition, the developing roller receives the application of a developing bias voltage set in advance and supplies the photoconductor drum 31 with the toner conveyed to the opposed position. This selectively supplies the toner to an exposure region on the photoconductor drum 31 irradiated with the light emitted from the laser scanning unit 25 and develops the electrostatic latent image formed on the surface of the photoconductor drum 31. It is to be noted that the developing device 33 is supplied with the toner from the toner container 36.

The primary transfer roller 34 receives the supply of a primary transfer current set in advance and transfers a toner image formed on the surface of the photoconductor drum 31 to the outer peripheral surface of the intermediate transfer belt 26. As shown in FIG. 3, the primary transfer roller 34 is provided to be opposed to the photoconductor drum 31 across the intermediate transfer belt 26. It is to be noted that the intermediate transfer belt 26 is an example of a transfer destination object according to this disclosure.

The drum cleaning member 35 removes a toner remaining on the surface of the photoconductor drum 31 after the primary transfer roller 34 transfers the toner image.

The laser scanning unit 25 emits the light based on the image data toward the surface of the photoconductor drum 31 of each of the image forming units 20.

The intermediate transfer belt 26 is an endless belt member to which the toner image formed on the surface of the photoconductor drum 31 of each of the image forming units 20 is transferred. For example, the intermediate transfer belt 26 is formed by using a resin material such as polyimide. The intermediate transfer belt 26 is stretched under predetermined tension by the drive roller 26A (see FIG. 3) and a stretching roller 26B (see FIG. 3). The drive roller 26A receives rotational driving force supplied from an unillustrated motor and rotates to cause the intermediate transfer belt 26 to rotate in a belt rotation direction D5 shown in FIG. 3. This causes the intermediate transfer belt 26 to convey the toner image transferred from each of the photoconductor drums 31 to a sheet transfer position by the secondary transfer roller 27. It is to be noted that the outer peripheral surface of the intermediate transfer belt 26 after the secondary transfer roller 27 transfers the toner images is cleaned by a belt cleaning member 26C (see FIG. 3).

The secondary transfer roller 27 receives the supply of a secondary transfer current set in advance and transfers the toner image transferred to the outer peripheral surface of the intermediate transfer belt 26 to a sheet supplied from the sheet feed portion 4. As shown in FIG. 3, the secondary transfer roller 27 is provided to be opposed to the drive roller 26A across the intermediate transfer belt 26.

As shown in FIG. 4, the size of the secondary transfer roller 27 in the axial direction (left-right direction D3) is smaller than the width (the size in the left-right direction D3) of the intermediate transfer belt 26. The outer peripheral surface of the intermediate transfer belt 26 therefore has non-contact regions A3 (see FIG. 4) out of contact with the secondary transfer roller 27. The non-contact regions A3 are regions located outside a contact region A2 (see FIG. 4) on the outer peripheral surface of the intermediate transfer belt 26 in contact with the secondary transfer roller 27 and including the ends of the intermediate transfer belt 26 in the width direction.

The fixing device 28 fixes the toner image transferred to the sheet by the secondary transfer roller 27 onto the sheet.

The sheet onto which the fixing device 28 fixes the toner image is discharged to the sheet discharge tray 29.

Of the four first power supplies 40, a first power supply 41 (see FIG. 2) is a constant current power supply that supplies the primary transfer roller 34 of the image forming unit 21 with the primary transfer current. Of the four first power supplies 40, a first power supply 42 (see FIG. 2) is a constant current power supply that supplies the primary transfer roller 34 of the image forming unit 22 with the primary transfer current. Of the four first power supplies 40, a first power supply 43 (see FIG. 2) is a constant current power supply that supplies the primary transfer roller 34 of the image forming unit 23 with the primary transfer current. Of the four first power supplies 40, a first power supply 44 (see FIG. 2) is a constant current power supply that supplies the primary transfer roller 34 of the image forming unit 24 with the primary transfer current. Each of the first power supplies 40 supplies the primary transfer current set by the control portion 7 to the primary transfer roller 34. For example, the primary transfer current is a current having negative polarity.

The second power supply 45 is a constant current power supply that supplies the secondary transfer roller 27 with the secondary transfer current. The second power supply 45 supplies the secondary transfer current set by the control portion 7 to the secondary transfer roller 27. For example, the secondary transfer current is a current having negative polarity.

The sensing portion 46 is used to sense the density and the position of a toner image transferred to each of the non-contact regions A3 (see FIG. 4) on the outer peripheral surface of the intermediate transfer belt 26. For example, the sensing portion 46 is a reflective photosensor including a light emitting portion that emits light toward each of the non-contact regions A3 of the intermediate transfer belt 26 and a light receiving portion that receives light emitted from the light emitting portion and reflected by the non-contact region A3 of the intermediate transfer belt 26. The sensing portion 46 then inputs, to the control portion 7, an electrical signal corresponding to the density of the toner image to be sensed. It is to be noted that the sensing portion 46 senses the density of the toner image in the predetermined width of the intermediate transfer belt 26 in the direction vertical to the belt rotation direction D5. The control portion 7 is capable of sensing the position of the toner image in the direction vertical to the belt rotation direction D5 on the basis of a result of the sensing by the sensing portion 46. In addition, in the image forming apparatus 100, sensing toner images described above may be formed in both the non-contact regions A3 outside the contact region A2 on the intermediate transfer belt 26 and the two sensing portions 46 may be provided at positions that allow the sensing toner images formed in the non-contact regions A3 at both ends to be sensed. In this case, in a condition adjustment process described below, an image formation condition is adjusted on the basis of results of the sensing by the two sensing portions 46.

As shown in FIG. 3, the sensing portion 46 is disposed on the downstream side of the transfer position of a toner image by the secondary transfer roller 27 in the belt rotation direction D5 and on the upstream side of a cleaning position by the belt cleaning member 26C on the outer peripheral surface of the intermediate transfer belt 26 in the belt rotation direction D5. In addition, the sensing portion 46 may be disposed on the downstream side of the photoconductor drum 31 of the image forming unit 24 in the belt rotation direction D5 and the upstream side of the transfer position of the toner image by the secondary transfer roller 27 in the belt rotation direction D5.

### [Configuration of Control Portion 7]

Next, the configuration of the control portion 7 will be described with reference to FIG. 2.

As shown in FIG. 2, the control portion 7 includes a print processing portion 50, a count processing portion 51, a first image processing portion 52, and a second image processing portion 53. Specifically, the ROM 12 of the control portion 7 stores a condition adjustment program in advance for causing the CPU 11 to function as each of the processing portions described above. The CPU 11 then functions as each of the processing portions described above by executing the condition adjustment program stored in the ROM 12.

It is to be noted that the condition adjustment program may be recorded in a computer-readable recording medium such as a CD, a DVD, and a flash memory, and read from the recording medium and stored in a storage device such as the storage portion 6. In addition, some or all of the print processing portion 50, the count processing portion 51, the first image processing portion 52, and the second image processing portion 53 may each include an electronic circuit such as an integrated circuit (ASIC).

The print processing portion 50 executes a print process including a normal image formation process of forming a print image based on print target image data in a print region A1 (see FIG. 4) on the intermediate transfer belt 26 by the image forming portion 3. The print region A1 is defined in advance. Specifically, in the normal image formation process, the print processing portion 50 controls the laser scanning unit 25 on the basis of the print target image data and forms an electrostatic latent image corresponding to each color on the photoconductor drum 31 of each of the image forming units 20 at a timing set in advance. This develops the electrostatic latent images formed on the photoconductor drums 31 as toner images in the respective image forming units 20 and the toner images are sequentially transferred to the intermediate transfer belt 26. After that, a color or monochrome image formed on the intermediate transfer belt 26 is transferred to a sheet by the secondary transfer roller 27 and the intermediate transfer belt 26 is cleaned by the belt cleaning member 26C.

It is to be noted that the print processing portion 50 controls the amount of laser light radiated by the laser scanning unit 25 in the normal image formation process on the basis of input and output characteristics indicating the relationship between the input image data and the amount of light radiated by the laser scanning unit 25 and the image data. In addition, the print processing portion 50 controls the developing bias voltage of each of the image forming units 20 in the normal image formation process such that the developing bias voltage has a value set in advance for each of the image forming units 20. Furthermore, the print processing portion 50 also controls the charged voltage of each of the image forming units 20, the primary transfer current, the secondary transfer current of the secondary transfer roller 27, and the like in the normal image formation process.

In addition, depending on a sheet type (such as plain paper or thick paper) and a printing type (monochrome printing or color printing), the print processing portion 50 sets the conveyance speed (referred to as “line speed” below) of the intermediate transfer belt 26 to speed set in advance for each printing type in the normal image formation process. For example, in a case where the sheet type is thick paper, the print processing portion 50 sets lower line speed than line speed set in a case where the sheet type is plain paper. In addition, in a case where the printing type is color printing, the print processing portion 50 sets lower line speed than line speed set in a case where the printing type is monochrome printing.

In addition, in the normal image formation process, the print processing portion 50 executes an inter-sheet process set in advance in the inter-sheet period between a process of forming an image based on image data for one page on the intermediate transfer belt 26 and a process of forming an image based on image data for the next one page on the intermediate transfer belt 26. For example, in the inter-sheet process, the drum cleaning member 35 cleans the photoconductor drum 31. In addition, in the inter-sheet process, various image processes and the like may be executed for image data corresponding to the next sheet in the normal image formation process.

The count processing portion 51 executes a count process of counting the number of copies in the image forming apparatus 100. The number of copies counted in the count process is used to measure the timing of executing a condition adjustment process described below by the first image processing portion 52 and the second image processing portion 53. Specifically, the count processing portion 51 counts the number of monochrome printing copies and the number of color printing copies corresponding to the respective printing types of monochrome printing and color printing as an execution history of monochrome printing and an execution history of color printing and stores the number of monochrome printing copies and the number of color printing copies in the storage portion 6. In addition, in a case where the first image processing portion 52 executes a condition adjustment process, the count processing portion 51 resets the number of monochrome printing copies to 0. In a case where the second image processing portion 53 executes a condition adjustment process, the count processing portion 51 resets the number of color printing copies to 0.

In addition, the count processing portion 51 updates a monochrome adjustment counter for sequentially switching the types of condition adjustment processes to be executed by the first image processing portion 52 whenever the first image processing portion 52 executes a condition adjustment process. In addition, the count processing portion 51 updates a color adjustment counter for sequentially switching the types of condition adjustment processes to be executed by the second image processing portion 53 whenever the second image processing portion 53 executes a condition adjustment process.

The first image processing portion 52 executes the condition adjustment process corresponding to the adjustment identification number indicated by the monochrome adjustment counter and the second image processing portion 53 executes the condition adjustment process corresponding to the adjustment identification number indicated by the color adjustment counter.

The first image processing portion 52 executes a condition adjustment process of adjusting an image formation condition of the image forming portion 3 on the image forming unit 24 of the plurality of image forming units 20 used for the monochrome printing. For example, the image formation condition includes the developing bias voltage, the amount of light of the laser scanning unit 25, the timing of radiating light by the laser scanning unit 25, the input and output characteristics, and the like. In particular, the first image processing portion 52 executes a plurality of types of condition adjustment processes in units of a specific number of condition adjustment processes in order whenever the execution history of the monochrome printing satisfies a monochrome adjustment condition set in advance. The execution history of the monochrome printing is the number of monochrome printing copies in this embodiment, but may be the execution time of the monochrome printing. It is to be noted that the monochrome adjustment condition is for the number of monochrome printing copies to reach 30 copies (an example of a first threshold) in this embodiment. It is to be noted that the first threshold used to determine whether or not the monochrome adjustment condition is satisfied is a larger value than a second threshold used to determine whether or not the color adjustment condition is satisfied in this embodiment. The second threshold will be described below. Meanwhile, the first threshold may be the same as the second threshold or may be smaller than the second threshold in another embodiment. In addition, the one specific number is used in this embodiment, but two or three specific numbers may be used as long as the specific numbers are less than all the types of condition adjustment processes in number.

The second image processing portion 53 executes condition adjustment processes on the image forming units 21 to 24 of the plurality of image forming units 20 used for the color printing. In particular, the second image processing portion 53 executes the plurality of types of condition adjustment processes in units of a specific number of condition adjustment processes in order whenever the execution history of the color printing satisfies a color adjustment condition set in advance. The execution history of the color printing is the number of color printing copies in this embodiment, but may be the execution time of the color printing. It is to be noted that the color adjustment condition is for the number of color printing copies to reach 15 copies (an example of a second threshold) in this embodiment. In addition, the one specific number is used in this embodiment, but two or three specific numbers may be used as long as the specific numbers are less than all the types of condition adjustment processes in number.

In this embodiment, the plurality of types of condition adjustment processes executed by the first image processing portion 52 or the second image processing portion 53 includes a developing bias voltage adjustment process, a light amount adjustment process, a positional misalignment adjustment process, and an input and output characteristic adjustment process. A condition adjustment process executed by the first image processing portion 52 will be sometimes referred to as a monochrome adjustment process below and a condition adjustment process executed by the second image processing portion 53 will be sometimes referred to as a color adjustment process below.

In each of the condition adjustment processes, a sensing image formation process of forming a sensing image used to adjust the image formation condition, a sensing process of sensing the density or the position of the sensing image, and a correction process of correcting the image formation condition on the basis of the density or the position of the sensing image sensed by the sensing process are executed.

In the sensing image formation process, a sensing toner image X10 (an example of a sensing image) used to adjust an image formation condition in the image forming portion 3 is formed in each of the non-contact regions A3 (see FIG. 4) outside the print region A1 (see FIG. 4) on the intermediate transfer belt 26 by the image forming portion 3 while the normal image formation process is in execution. In particular, the sensing image formation process forms the sensing toner image X10 in a period other than the inter-sheet period in the normal image formation process. The print region A1 is a region inside the contact region A2 (see FIG. 4) on the outer peripheral surface of the intermediate transfer belt 26. For example, the print region A1 is a contact region with a sheet having the maximum size usable to the image forming apparatus 100 on the outer peripheral surface of the intermediate transfer belt 26. It is to be noted that the sensing image formation process may be executed in the inter-sheet period or may be executed after the normal image formation process is executed in other embodiments.

In addition, in the sensing image formation process, the sensing toner image X10 is formed on the intermediate transfer belt 26 on the basis of sensing image data set in advance and corresponding to each color. For example, the sensing toner image X10 is a rectangular single-colored image.

Specifically, in the sensing image formation process executed by the first image processing portion 52, the sensing toner image X10 corresponding to K (black) is formed on the intermediate transfer belt 26. In particular, in a case where the light amount adjustment process, the developing bias voltage adjustment process, or the input and output characteristic adjustment process is executed, the first image processing portion 52 forms the respective sensing toner images X10 of K (black) corresponding to densities set in advance and different from each other on the intermediate transfer belt 26. In addition, in a case where the positional misalignment adjustment process is executed, the first image processing portion 52 forms the respective sensing toner images X10 of K (black) having positions different from each other in the belt rotation direction D5 of the belt 26 at positions set in advance on the intermediate transfer belt 26. It is to be noted that the sensing toner image X10 is formed on the intermediate transfer belt 26 in the sensing image formation process in the monochrome adjustment process in this embodiment while the normal print image formation process for one page is in execution.

Meanwhile, in the sensing image formation process executed by the second image processing portion 53, the plurality of sensing toner images X10 corresponding to K (black), C (cyan), M (magenta), and Y (yellow) is formed in order on the intermediate transfer belt 26. In particular, in a case where the light amount adjustment process, the developing bias voltage adjustment process, or the input and output characteristic adjustment process is executed, the second image processing portion 53 forms the plurality of respective sensing toner images X10 of K (black), C (cyan), M (magenta), and Y (yellow) corresponding to densities set in advance and different from each other on the intermediate transfer belt 26. In addition, in a case where the positional misalignment adjustment process is executed, the second image processing portion 53 forms the plurality of respective sensing toner images X10 of K (black), C (cyan), M (magenta), and Y (yellow) having positions different from each other in the belt rotation direction D5 of the belt 26 at positions set in advance on the intermediate transfer belt 26. It is to be noted that, in the sensing image formation process in the color adjustment process in this embodiment, the sensing toner image X10 may be formed on the intermediate transfer belt 26 while the normal print image formation process for a plurality of pages is in execution or the sensing toner image X10 may be formed on the intermediate transfer belt 26 while the normal print image formation process for one page is in execution.

In the sensing process, the density and the position of the sensing toner image X10 formed in each of the non-contact regions A3 of the intermediate transfer belt 26 are sensed by using the sensing portion 46. It is to be noted that the sensing process may sense any one of the density and the position of the sensing toner image X10 alone. For example, in a case where the light amount adjustment process, the developing bias voltage adjustment process, or the input and output characteristic adjustment process is executed, it is sufficient if at least the density of the sensing toner image X10 is sensed. In a case where the positional misalignment adjustment process is executed, it is sufficient if the position of the sensing toner image X10 is sensed.

In the correction process, a correction process of adjusting the image formation condition is executed on the basis of a result of the sensing by the second image processing portion 53. Specifically, the first image processing portion 52 executes the correction process on the image forming unit 24 corresponding to K (black). In addition, the second image processing portion 53 executes the correction processes on the image forming units 21 to 24 corresponding to K (black), C (cyan), M (magenta), and Y (yellow).

Specifically, in the correction process in the developing bias voltage adjustment process, the developing bias voltage that is one of the image formation conditions is adjusted for the image forming unit 20 corresponding to the sensing toner image X10 on the basis of the difference between the density of the sensing toner image X10 sensed by the second image processing portion 53 and a first reference density set in advance. It is to be noted that the first reference density is an initial value set in advance, the density of the sensing toner image X10 sensed at the time of the adjustment of the immediately preceding image formation condition, or the like.

In the correction process in the light amount adjustment process, the amount of light of the laser scanning unit 25 that is one of the image formation conditions is adjusted for the image forming unit 20 corresponding to the sensing toner image X10 on the basis of the difference between the density of the sensing toner image X10 sensed by the second image processing portion 53 and a second reference density set in advance. It is to be noted that the second reference density is an initial value set in advance, the density of the sensing toner image X10 sensed at the time of the adjustment of the immediately preceding image formation condition, or the like.

In the correction process in the positional misalignment adjustment process, a light radiation timing (image formation timing) by the laser scanning unit 25 that is one of the image formation conditions is adjusted for the image forming unit 20 corresponding to the sensing toner image X10 on the basis of the difference between the sensing position of the sensing toner image X10 sensed by using the second image processing portion 53 and a specific position set in advance.

In the correction process in the input and output characteristic adjustment process, the input and output characteristics that are one of the image formation conditions are adjusted for the image forming unit 20 corresponding to the sensing toner image X10 on the basis of the difference between the density of the sensing toner image X10 sensed by the second image processing portion 53 and a third reference density set in advance. The input and output characteristic adjustment process is sometimes referred to as a gamma correction process in general. It is to be noted that the third reference density is an initial value set in advance, the density of the sensing toner image X10 sensed at the time of the adjustment of the immediately preceding image formation condition, or the like.

It is to be noted that the image formation conditions adjusted in the condition adjustment process are not limited to what are described here. For example, the image formation conditions may include the charged voltage, the primary transfer current, and the secondary transfer current.

In addition, the storage portion 6 stores association information in which an adjustment identification number and the contents of a condition adjustment process are associated. Specifically, in the association information, the adjustment identification number “1” is associated with the developing bias voltage adjustment process and the adjustment identification number “2” is associated with the light amount adjustment process. In addition, in the association information, the adjustment identification number “3” is associated with the positional misalignment adjustment process and the adjustment identification number “4” is associated with the input and output characteristic adjustment process. The first image processing portion 52 then executes the condition adjustment process corresponding to the adjustment identification number indicated by the monochrome adjustment counter and the second image processing portion 53 executes the condition adjustment process corresponding to the adjustment identification number indicated by the color adjustment counter.

Incidentally, it takes time to collectively form sensing toner images used for the plurality of types of condition adjustment processes. Therefore, when the condition adjustment processes are increased in execution frequency, the printing efficiency may be influenced. Meanwhile, when the condition adjustment processes are decreased in execution frequency, the condition adjustment processes have longer execution intervals and the image quality may be unstable. In contrast, the image forming apparatus 100 according to this embodiment makes it possible to efficiently execute the respective various condition adjustment processes suitable to color printing and monochrome printing and stabilize the image quality.

### [Adjustment Control Process]

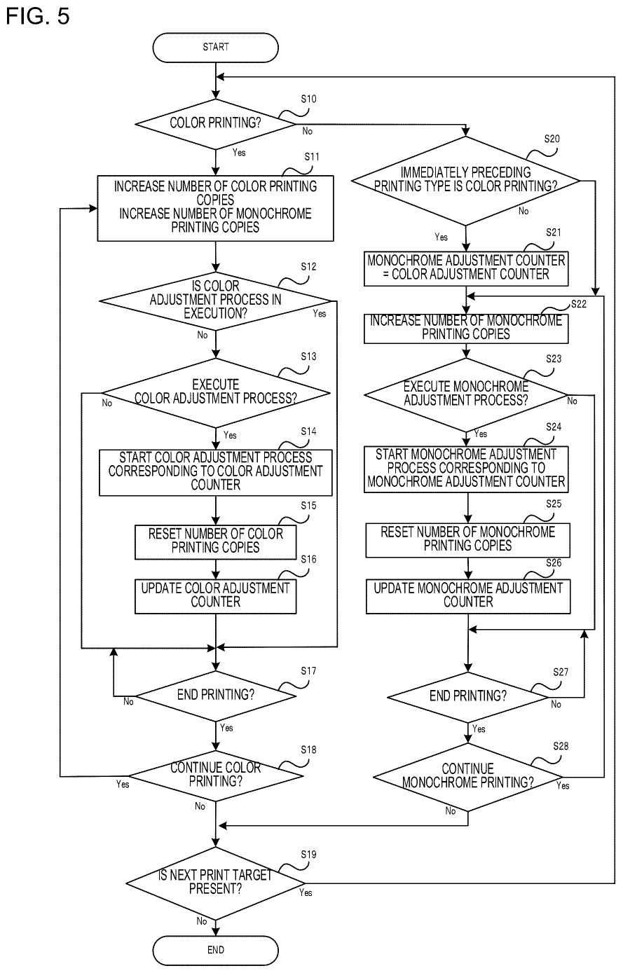

The following describes an image forming method according to this disclosure along with examples of procedures of an adjustment control process that is executed by the control portion 7 in the image forming apparatus 100 with reference to FIG. 5. Here, steps S10, S11, . . . denote the numbers of processing procedures (steps) that are executed by the control portion 7. It is to be noted that the control portion 7 starts to execute the adjustment control process when a normal image formation process of printing a print image on a sheet on the basis of print target image data is executed. That is, the adjustment control process is executed in parallel with the normal image formation process while the normal image formation process is in execution.

### <Step S10>

In step S10, the control portion 7 determines whether or not color printing is executed in the normal image formation process. Here, in a case where it is determined that the color printing is executed (S10: Yes), the process transitions to step S11. In contrast, in a case where it is determined that the color printing is not executed and the monochrome printing is executed (S10: No), the process transitions to step S21.

Specifically, the print processing portion 50 of the control portion 7 sometimes selects monochrome printing or color printing automatically on the basis of print target image data when the normal image formation process is executed. In this case, in step S10, the control portion 7 determines whether or not color printing is executed depending on a result of the selection by the print processing portion 50. In addition, the print processing portion 50 of the control portion 7 executes any of monochrome printing and color printing in accordance with a monochrome printing mode or a color printing mode selected by a user operation when a print process based on print target image data is started. In this case, in step S10, the control portion 7 determines whether or not color printing is executed depending on the monochrome printing mode or the color printing mode selected by the user operation. In addition, the print processing portion 50 stores the printing type of the current print target in the storage portion 6 as information about the immediately preceding printing type when step S10 is executed.

### <Step S11>

In step S11, the count processing portion 51 of the control portion 7 increases both the number of color printing copies and the number of monochrome printing copies by one. It is to be noted that the number of color printing copies and the number of monochrome printing copies in the image forming apparatus 100 are each 0.

### <Step S12>

In step S12, the second image processing portion 53 of the control portion 7 determines whether or not the color adjustment process is in execution. Here, in a case where it is determined that the color adjustment process is in execution (S12: Yes), the process transitions to step S17. In a case where it is determined that the color adjustment process is not in execution (S12: No), the process transitions to step S13. That is, in a case where the color adjustment process is executed while the normal image formation process for a plurality of pages is in execution (S12: Yes), the process transitions to step S17 and steps S13 to S16 are omitted.

It is to be noted that step S12 above may be omitted in a case where the sensing image formation process in the color adjustment process is executed while the normal image formation process for one page is in executed. In particular, only any one of the plurality of types of condition adjustment processes is executed in the color adjustment process and it is thus possible that the condition adjustment process is executed while the normal image formation process for one page is in executed.

### <Step S13>

In step S13, the second image processing portion 53 of the control portion 7 determines whether or not the color adjustment condition is satisfied. Specifically, in a case where the number of color printing copies reaches 15 copies, the second image processing portion 53 determines that the color adjustment condition is satisfied in this embodiment. Here, when it is determined that the color adjustment condition is satisfied (S13: Yes), the process transitions to step S14. In a case where it is determined that the color adjustment condition is not satisfied (S13: No), the process transitions to step S17.

### <Step S14>

In step S14, the second image processing portion 53 of the control portion 7 starts the condition adjustment process of the plurality of types of condition adjustment processes corresponding to the value of the color adjustment counter as the color adjustment process. That is, the second image processing portion 53 executes the plurality of types of condition adjustment processes one by one in order whenever the number of color printing copies reaches 15 copies.

Specifically, in a case where the color adjustment counter is “1”, the second image processing portion 53 executes the developing bias voltage adjustment process. In a case where the color adjustment counter is “2”, the second image processing portion 53 executes the light amount adjustment process. In addition, in a case where the color adjustment counter is “3”, the second image processing portion 53 executes the positional misalignment adjustment process. In a case where the color adjustment counter is “4”, the second image processing portion 53 executes the input and output characteristic adjustment process. It is to be noted that the color adjustment counter has an initial value of “1” and the initial value is updated in the order of “1” to “4” in step S16 described below. As described above, the sensing image formation process in the condition adjustment process is executed along with the normal image formation process. The sensing toner image X10 is formed in each of the non-contact regions A3 outside the print region A1 in which a print image based on the image data is formed in the normal image formation process.

### <Step S15>

In step S15, the second image processing portion 53 of the control portion 7 resets the number of color printing copies to 0. In this way, the number of color printing copies is managed through step S11 and step S15 in the adjustment control process, thereby executing the color adjustment process whenever the color printing is applied to 15 sheets.

### <Step S16>

In step S16, the count processing portion 51 of the control portion 7 updates the color adjustment counter. Specifically, in a case where the color adjustment counter is “1”, the count processing portion 51 updates the color adjustment counter with “2”. In a case where the color adjustment counter is “2”, the count processing portion 51 updates the color adjustment counter with “3”. In addition, in a case where the color adjustment counter is “3”, the count processing portion 51 updates the color adjustment counter with “4”. In a case where the color adjustment counter is “4”, the count processing portion 51 updates the color adjustment counter with “1”.

### <Step S17>

In step S17, the second image processing portion 53 of the control portion 7 determines whether or not the normal image formation process for one page comes to an end. Here, when it is determined that the normal image formation process for one page comes to an end (S17: Yes), the process transitions to step S18. When it is determined that the normal image formation process for one page does not come to an end (S17: No), step S17 is repeatedly executed.

### <Step S18>

In step S18, the second image processing portion 53 of the control portion 7 determines whether or not the color printing continues. Specifically, in a case where the printing type corresponding to the next print target image data is color printing, the second image processing portion 53 determines that the color printing continues. In contrast, in a case where the printing type corresponding to the next print target image data is monochrome printing, the second image processing portion 53 determines that the color printing does not continue. In addition, in a case where the next print target image data is not present, the second image processing portion 53 also determines that the color printing does not continue. Here, when it is determined that the color printing continues (S18: Yes), the process is returned to step S11. When it is determined that the color printing does not continue (S18: No), the process transitions to step S19.

### <Step S19>

In step S19, the control portion 7 determines whether or not the next print target image data is present. Here, when it is determined that the next print target image data is present (S19: Yes), the process is returned to step S10. When it is determined that the next print target image data is not present (S19: No), the adjustment control process comes to an end.

### <Step S20>

In step S20, the first image processing portion 52 of the control portion 7 determines whether or not the printing type of the print process based on the immediately preceding print target image data is color printing. Specifically, the first image processing portion 52 determines whether or not the immediately preceding printing type is color printing on the basis of information about the immediately preceding printing type stored in the storage portion 6 by the print processing portion 50. Here, when it is determined that the immediately preceding printing type is color printing (S20: Yes), the process transitions to step S21. When it is determined that the immediately preceding printing type is not color printing (S20: No), the process transitions to step S22.

It is to be noted that the control portion 7 may store the type (the color adjustment process or the monochrome adjustment process) of the condition adjustment process executed immediately before in the storage portion 6 in the adjustment control process. In this case, in step S20, the first image processing portion 52 may cause the process to transition to step S21 in a case where the condition adjustment process executed immediately before is the color adjustment process instead of the printing type of the print process based on the immediately preceding print target image data. In a case where the monochrome adjustment condition is satisfied and the condition adjustment process executed immediately before is executed by the second image processing portion 53, the first image processing portion 52 hereby executes the condition adjustment processes in order from the condition adjustment process after the condition adjustment process executed immediately before by the second image processing portion 53.

### <Step S21>

In step S21, the first image processing portion 52 of the control portion 7 updates the monochrome adjustment counter with the value of the color adjustment counter. That is, in a case where the printing type by the image forming portion 3 is switched from color printing to monochrome printing (S20: Yes), the first image processing portion 52 updates the monochrome adjustment counter with the adjustment identification number corresponding to the condition adjustment process after the condition adjustment process executed immediately before by the second image processing portion 53. This causes the first image processing portion 52 to execute the condition adjustment process corresponding to the adjustment identification number after the adjustment identification number corresponding to the color adjustment process executed immediately before by the second image processing portion 53 in a case where the monochrome adjustment condition is satisfied for the first time in step S23 described below after the printing type by the image forming portion 3 is switched from color printing to monochrome printing (S23: Yes).

It is to be noted that, in a case where the printing type by the image forming portion 3 is switched from monochrome printing to color printing, the second image processing portion 53 does not update the color adjustment counter with the adjustment identification number corresponding to the condition adjustment process after the condition adjustment process executed immediately before by the second image processing portion 53. This causes the second image processing portion 53 to execute the condition adjustment process corresponding to the adjustment identification number after the adjustment identification number corresponding to the color adjustment process executed immediately before by the second image processing portion 53 even in a case where the color adjustment condition is satisfied for the first time in step S13 after the printing type by the image forming portion 3 is switched from monochrome printing to color printing (S13: Yes).

### <Step S22>

In step S22, the count processing portion 51 of the control portion 7 increases the number of monochrome printing copies by one.

### <Step S23>

In step S23, the first image processing portion 52 of the control portion 7 determines whether or not the monochrome adjustment condition is satisfied. Specifically, in a case where the number of monochrome printing copies reaches 30 copies, the first image processing portion 52 determines that the monochrome adjustment condition is satisfied in this embodiment. Here, when it is determined that the monochrome adjustment condition is satisfied (S23: Yes), the process transitions to step S24. In a case where it is determined that the monochrome adjustment condition is not satisfied (S23: No), the process transitions to step S27.

It is to be noted that the first image processing portion 52 of the control portion 7 may determine whether or not the monochrome adjustment process is in execution in the period between steps S22 to S23 as in step S12. In a case where the monochrome adjustment process is executed while the normal image formation process for a plurality of pages is in execution, the process may transition to step S27 and steps S23 to S26 may be omitted.

### <Step S24>

In step S24, the first image processing portion 52 of the control portion 7 starts the condition adjustment process of the plurality of types of condition adjustment processes corresponding to the value of the monochrome adjustment counter as the monochrome adjustment process. That is, the first image processing portion 52 executes the plurality of types of condition adjustment processes one by one in order whenever the number of monochrome printing copies reaches 30 copies.

Specifically, in a case where the monochrome adjustment counter is “1”, the first image processing portion 52 executes the developing bias voltage adjustment process. In a case where the monochrome adjustment counter is “2”, the first image processing portion 52 executes the light amount adjustment process. In addition, in a case where the monochrome adjustment counter is “3”, the second image processing portion 53 executes the positional misalignment adjustment process. In a case where the monochrome adjustment counter is “4”, the second image processing portion 53 executes the input and output characteristic adjustment process. It is to be noted that the monochrome adjustment counter has an initial value of “1”, and the initial value is updated with the value of the color adjustment counter in step S21 or updated in the order of “1” to “4” in step S26 described below. As described above, the sensing image formation process in the condition adjustment process is executed along with the normal image formation process. The sensing toner image X10 is formed in each of the non-contact regions A3 outside the print region A1 in which a print image based on the image data is formed in the normal image formation process.

In particular, as described above, in a case where the printing type by the image forming portion 3 is switched from color printing to monochrome printing, the first image processing portion 52 updates the monochrome adjustment counter with the value of the color adjustment counter in step S21. The condition adjustment process corresponding to the adjustment identification number after the adjustment identification number corresponding to the color adjustment process executed immediately before by the second image processing portion 53 is therefore executed in step S24 after the printing type by the image forming portion 3 is switched from color printing to monochrome printing.

### <Step S25>

In step S25, the first image processing portion 52 of the control portion 7 resets the number of monochrome printing copies to 0. In this way, the number of monochrome printing copies is managed through step S22 and step S25 in the adjustment control process, thereby executing the monochrome adjustment process whenever the monochrome printing is applied to 30 sheets.

### <Step S26>

In step S26, the count processing portion 51 of the control portion 7 updates the monochrome adjustment counter. Specifically, in a case where the monochrome adjustment counter is “1”, the count processing portion 51 updates the monochrome adjustment counter with “2”. In a case where the monochrome adjustment counter is “2”, the count processing portion 51 updates the monochrome adjustment counter with “3”. In addition, in a case where the monochrome adjustment counter is “3”, the count processing portion 51 updates the monochrome adjustment counter with “4”. In a case where the monochrome adjustment counter is “4”, the count processing portion 51 updates the monochrome adjustment counter with “1”.

### <Step S27>

In step S27, the first image processing portion 52 of the control portion 7 determines whether or not the normal image formation process for one page comes to an end. Here, when it is determined that the normal image formation process for one page comes to an end (S27: Yes), the process transitions to step S27. When it is determined that the normal image formation process for one page does not come to an end (S27: No), step S27 is repeatedly executed.

### <Step S28>

In step S28, the first image processing portion 52 of the control portion 7 determines whether or not the monochrome printing continues. Specifically, in a case where the printing type corresponding to the next print target image data is monochrome printing, the first image processing portion 52 determines that the monochrome printing continues. In contrast, in a case where the printing type corresponding to the next print target image data is color printing, the first image processing portion 52 determines that the monochrome printing does not continue. In addition, in a case where the next print target image data is not present, the first image processing portion 52 also determines that the monochrome printing does not continue. Here, when it is determined that the monochrome printing continues (S28: Yes), the process is returned to step S22. When it is determined that the monochrome printing does not continue (S28: No), the process transitions to step S19.

### [Example of Result of Execution of Condition Control Process]

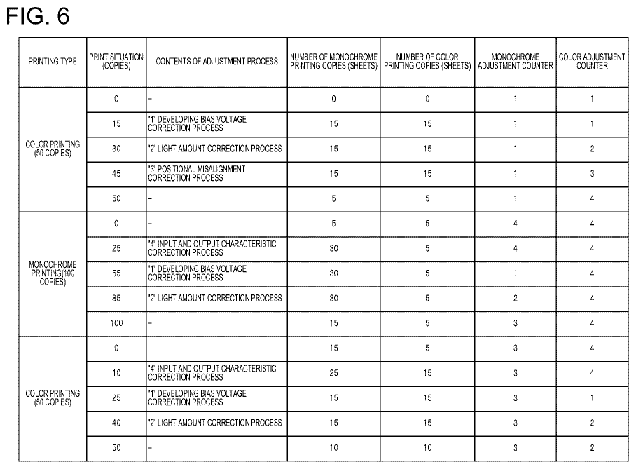

An example of a result of the execution of the adjustment control process by the image forming apparatus 100 will be described below with reference to FIG. 6. Specifically, FIG. 6 shows results of the execution of the adjustment control processes executed in a case where color printing is applied to 50 sheets as a first print job, monochrome printing is applied to 100 sheets as a second print job, and color printing is applied to 50 sheets as a third print job. It is to be noted that a case where the three print jobs of the first print job, the second print job, and the third print job are executed in series will be here described as an example. Meanwhile, a case where color printing and monochrome printing are executed in one print job in a mixed manner as in the first print job, the second print job, and the third print job is also similarly processed.

As shown in FIG. 6, the number of monochrome printing copies and the number of color printing copies are each assumed to be 0 when the first print job is started. After that, when printing is executed on the 15-th sheet in the first print job, the number of color printing copies reaches 15 copies that is the second threshold (S13: Yes). The color adjustment counter then has an initial value of “1”. The second image processing portion 53 therefore executes the developing bias voltage adjustment process corresponding to the adjustment identification number “1” as the color adjustment process (S14).

Next, when printing is executed on the 30-th sheet in the first print job, the number of color printing copies reaches 15 copies that is the second threshold (S13: Yes). The color adjustment counter is then updated in step S16 with “2”. The second image processing portion 53 therefore executes the light amount adjustment process corresponding to the adjustment identification number “2” as the color adjustment process (S14).

Similarly, when printing is executed on the 45-th sheet in the first print job, the number of color printing copies reaches 15 copies that is the second threshold (S13: Yes). The color adjustment counter is then updated in step S16 with “3”. The second image processing portion 53 therefore executes the positional misalignment adjustment process corresponding to the adjustment identification number “3” as the color adjustment process (S14).

When printing is executed on the 50-th sheet in the first print job, the first print job then comes to an end and the second print job is started. In the first print job, the number of monochrome printing copies and the number of color printing copies are each increased up to “5” in step S11. In addition, the value of the color adjustment counter is updated in step S16 with “4” and the value of the monochrome adjustment counter remains “1”.

Next, when printing is executed on the 25-th sheet in the second print job, the number of monochrome printing copies reaches 30 copies that is the first threshold (S23: Yes). The monochrome adjustment counter is then updated in step S21 with “4”, which is the value of the color adjustment counter. The first image processing portion 52 therefore executes the input and output characteristic adjustment process corresponding to the adjustment identification number “4” as the monochrome adjustment process (S24).

Subsequently, when printing is executed on the 55-th sheet in the second print job, the number of monochrome printing copies reaches 30 copies that is the second threshold (S23: Yes). The monochrome adjustment counter is then updated in step S26 with “1”. The first image processing portion 52 therefore executes the developing bias voltage adjustment process corresponding to the adjustment identification number “1” as the monochrome adjustment process (S24).

Similarly, when printing is executed on the 85-th sheet in the second print job, the number of monochrome printing copies reaches 30 copies that is the first threshold (S23: Yes). The monochrome adjustment counter is then updated in step S26 with “2”. The first image processing portion 52 therefore executes the light amount adjustment process corresponding to the adjustment identification number “2” as the monochrome adjustment process (S24).

When printing is executed on the 100-th sheet in the second print job, the second print job then comes to an end and the third print job is started. In the second print job, the number of monochrome printing copies is increased up to “15” in step S22. Meanwhile, the number of color printing copies remains “5”. In addition, the value of the monochrome adjustment counter is updated in step S26 with “3” and the value of the color adjustment counter remains “4”.

Subsequently, when printing is executed on the 10-th sheet in the third print job, the number of color printing copies reaches 15 copies that is the second threshold (S13: Yes). The color adjustment counter is then “4”. The second image processing portion 53 therefore executes the input and output characteristic adjustment process corresponding to the adjustment identification number “4” as the color adjustment process (S14).

Next, when printing is executed on the 25-th sheet in the third print job, the number of color printing copies reaches 15 copies that is the second threshold (S13: Yes). The color adjustment counter is then updated in step S16 with “1”. The second image processing portion 53 therefore executes the developing bias voltage adjustment process corresponding to the adjustment identification number “1” as the color adjustment process (S14).

Similarly, when printing is executed on the 40-th sheet in the third print job, the number of color printing copies reaches 15 copies that is the second threshold (S13: Yes). The color adjustment counter is then updated in step S16 with “2”. The second image processing portion 53 therefore executes the light amount adjustment process corresponding to the adjustment identification number “2” as the color adjustment process (S14).

As described above, in the image forming apparatus 100, the execution of the adjustment control process causes the plurality of types of condition adjustment processes to be separately executed one by one in order in the monochrome printing or the color printing on the basis of the execution history of the monochrome printing or the execution history of the color printing whenever the execution condition of the condition adjustment process is satisfied. This makes it possible to decrease the execution time of the one condition adjustment process in comparison with a case where sensing toner images used for the plurality of types of condition adjustment processes are collectively formed. In addition, the condition adjustment processes are each increased in execution frequency and it is thus possible to stabilize the image quality.

In particular, in a case where the monochrome adjustment condition is satisfied for the first time after the printing type by the image forming portion 3 is switched from color printing to monochrome printing, the first image processing portion 52 executes the condition adjustment processes in order from the condition adjustment process after the condition adjustment process executed immediately before by the second image processing portion 53. This is because the image forming unit 24 of K (black) to be adjusted in the monochrome adjustment process is also adjusted in the color adjustment process executed by the second image processing portion 53. The condition adjustment process of a type subsequent to the color adjustment process is hereby executed in the monochrome adjustment process. The condition adjustment process of the type that has been already executed in the color adjustment process is thus prevented from being repeatedly executed and it is possible to stabilize the image quality of monochrome printing.

In addition, in a case where the color adjustment condition is satisfied for the first time after the printing type by the image forming portion 3 is switched from monochrome printing to color printing, the second image processing portion 53 executes the condition adjustment processes in order from the condition adjustment process after the condition adjustment process executed immediately before by the second image processing portion 53. This is because the image forming units 21 to 23 of C (cyan), M (magenta), and Y (yellow) of the image forming units to be adjusted in the color adjustment process are not adjusted in the monochrome adjustment process executed by the first image processing portion 52. The condition adjustment process of a type subsequent to the past color adjustment process is here executed in the color adjustment process. It is thus possible to execute the plurality of types of condition adjustment processes in order set in advance and stabilize the image quality of color printing.

### SUPPLEMENTARY NOTES OF INVENTION

The gist of the invention extracted from the embodiment described above will be supplementarily noted below. It is to be noted that the respective configurations and the respective processing functions described in the following supplementary notes can be sorted out and used in any combination.

### Supplementary Note 1

An image forming apparatus including:
an image forming portion including a plurality of image forming units corresponding to a plurality of colors, the image forming portion being configured to execute monochrome printing of printing a monochrome image or color printing of printing a color image on the basis of input image data;
a first image processing portion configured to execute a plurality of types of condition adjustment processes of adjusting an image formation condition of the image forming portion on the image forming unit of the plurality of image forming units used for the monochrome printing in units of a specific number of condition adjustment processes in order whenever an execution history of the monochrome printing satisfies a monochrome adjustment condition set in advance, the plurality of types of condition adjustment processes being set in advance; and a second image processing portion configured to execute the plurality of types of condition adjustment processes on the image forming unit of the plurality of image forming units used for the color printing in units of a specific number of condition adjustment processes in order whenever an execution history of the color printing satisfies a color adjustment condition set in advance.

### Supplementary Note 2

The image forming apparatus according to Supplementary Note 1, in which, in a case where the monochrome adjustment condition is satisfied for a first time after a printing type by the image forming portion is switched from the color printing to the monochrome printing, the first image processing portion executes the condition adjustment processes in order from the condition adjustment process after the condition adjustment process executed immediately before by the second image processing portion.

### Supplementary Note 3

The image forming apparatus according to Supplementary Note 1 or 2, in which, in a case where the color adjustment condition is satisfied for a first time after the printing type by the image forming portion is switched from the monochrome printing to the color printing, the second image processing portion executes the condition adjustment processes in order from the condition adjustment process after the condition adjustment process executed immediately before by the second image processing portion.

### Supplementary Note 4

The image forming apparatus according to any of Supplementary Notes 1 to 3, including a count processing portion configured to count a number of copies or execution time in the monochrome printing as the execution history of the monochrome printing and count a number of copies or execution time in the color printing as the execution history of the color printing, in which the count processing portion adds the number of copies or the execution time in the color printing to the execution history of the monochrome printing, the monochrome adjustment condition is for the execution history of the monochrome printing to reach a first threshold set in advance, and the color adjustment condition is for the execution history of the color printing to reach a second threshold set in advance.

### Supplementary Note 5

The image forming apparatus according to any of Supplementary Notes 1 to 4, in which the condition adjustment processes include any two or more of a developing bias voltage adjustment process, a light amount adjustment process, a positional misalignment adjustment process, and an input and output characteristic adjustment process.

### Supplementary Note 6

The image forming apparatus according to any of Supplementary Notes 1 to 5, in which, while a normal image formation process of forming a print image based on print target image data in a print region on a transfer destination object by the image forming portion is in execution, the first image processing portion and the second image processing portion each form a sensing image used for any of the condition adjustment processes in each of regions outside the print region on the transfer destination object by the image forming portion, the print region being defined in advance.

### Supplementary Note 7

The image forming apparatus according to any of Supplementary Notes 1 to 6, in which the specific number is 1.

### Supplementary Note 8

The image forming apparatus according to any of Supplementary Notes 1 to 7, in which, in a case where the monochrome adjustment condition is satisfied and the condition adjustment process executed immediately before is executed by the second image processing portion, the first image processing portion executes the condition adjustment processes in order from the condition adjustment process after the condition adjustment process executed immediately before by the second image processing portion.

### Supplementary Note 9

An image forming method, in which a processor of an image forming apparatus including an image forming portion that includes a plurality of image forming units corresponding to a plurality of colors and is configured to execute monochrome printing of printing a monochrome image or color printing of printing a color image on the basis of input image data executes:
a step of executing a plurality of types of condition adjustment processes of adjusting an image formation condition of the image forming portion on the image forming unit of the plurality of image forming units used for the monochrome printing in units of a specific number of condition adjustment processes in order whenever an execution history of the monochrome printing satisfies a monochrome adjustment condition set in advance, the plurality of types of condition adjustment processes being set in advance; and
a step of executing the plurality of types of condition adjustment processes on the image forming unit of the plurality of image forming units used for the color printing in units of a specific number of condition adjustment processes in order whenever an execution history of the color printing satisfies a color adjustment condition set in advance.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus comprising:
an image forming portion including a plurality of image forming units corresponding to a plurality of colors, the image forming portion being configured to execute monochrome printing of printing a monochrome image or color printing of printing a color image on a basis of input image data;
a first image processing portion configured to execute a plurality of types of condition adjustment processes of adjusting an image formation condition of the image forming portion on the image forming unit of the plurality of image forming units used for the monochrome printing in units of a specific number of condition adjustment processes in order whenever an execution history of the monochrome printing satisfies a monochrome adjustment condition set in advance, the plurality of types of condition adjustment processes being set in advance; and
a second image processing portion configured to execute the plurality of types of condition adjustment processes on the image forming unit of the plurality of image forming units used for the color printing in units of a specific number of condition adjustment processes in order whenever an execution history of the color printing satisfies a color adjustment condition set in advance.

2. The image forming apparatus according to claim 1, wherein, in a case where the monochrome adjustment condition is satisfied for a first time after a printing type by the image forming portion is switched from the color printing to the monochrome printing, the first image processing portion executes the condition adjustment processes in order from the condition adjustment process after the condition adjustment process executed immediately before by the second image processing portion.

3. The image forming apparatus according to claim 2, wherein, in a case where the color adjustment condition is satisfied for a first time after the printing type by the image forming portion is switched from the monochrome printing to the color printing, the second image processing portion executes the condition adjustment processes in order from the condition adjustment process after the condition adjustment process executed immediately before by the second image processing portion.

4. The image forming apparatus according to claim 1, comprising a count processing portion configured to count a number of copies or execution time in the monochrome printing as the execution history of the monochrome printing and count a number of copies or execution time in the color printing as the execution history of the color printing, wherein
the count processing portion adds the number of copies or the execution time in the color printing to the execution history of the monochrome printing,
the monochrome adjustment condition is for the execution history of the monochrome printing to reach a first threshold set in advance, and
the color adjustment condition is for the execution history of the color printing to reach a second threshold set in advance.

5. The image forming apparatus according to claim 1, wherein the condition adjustment processes include any two or more of a developing bias voltage adjustment process, a light amount adjustment process, a positional misalignment adjustment process, and an input and output characteristic adjustment process.

6. The image forming apparatus according to claim 1, wherein, while a normal image formation process of forming a print image based on print target image data in a print region on a transfer destination object by the image forming portion is in execution, the first image processing portion and the second image processing portion each form a sensing image used for any of the condition adjustment processes in each of regions outside the print region on the transfer destination object by the image forming portion, the print region being defined in advance.

7. The image forming apparatus according to claim 1, wherein the specific number is 1.

8. The image forming apparatus according to claim 1, wherein, in a case where the monochrome adjustment condition is satisfied and the condition adjustment process executed immediately before is executed by the second image processing portion, the first image processing portion executes the condition adjustment processes in order from the condition adjustment process after the condition adjustment process executed immediately before by the second image processing portion.

9. An image forming method, wherein a processor of an image forming apparatus including an image forming portion that includes a plurality of image forming units corresponding to a plurality of colors and is configured to execute monochrome printing of printing a monochrome image or color printing of printing a color image on a basis of input image data executes:
a step of executing a plurality of types of condition adjustment processes of adjusting an image formation condition of the image forming portion on the image forming unit of the plurality of image forming units used for the monochrome printing in units of a specific number of condition adjustment processes in order whenever an execution history of the monochrome printing satisfies a monochrome adjustment condition set in advance, the plurality of types of condition adjustment processes being set in advance; and
a step of executing the plurality of types of condition adjustment processes on the image forming unit of the plurality of image forming units used for the color printing in units of a specific number of condition adjustment processes in order whenever an execution history of the color printing satisfies a color adjustment condition set in advance.
